(19) United States
(12) Patent Application Publication
(10) Pub. No.: US 2026/0103107 A1
(43) Pub. Date: Apr. 16, 2026

(54) METHOD AND SYSTEM FOR LOW VOLTAGE BATTERY REPLACEMENT

(71) Applicant: Ford Global Technologies, LLC, Dearborn, MI (US)

(72) Inventors: William David Treharne, Ypsilanti, MI (US); Stuart Salter, White Lake, MI (US); David Celinske, Wolverine Lake, MI (US); Josephine Lee, Novi, MI (US)

(21) Appl. No.: 18/915,754

(22) Filed: Oct. 15, 2024

(51) Int. Cl. B60L 53/80; H01M 10/42

(52) U.S. Cl. CPC B60L 53/80; H01M 10/425; H01M 2220/20

(57) ABSTRACT

Systems and methods for operating a vehicle that includes a low voltage battery are described. In one example, a human/machine interface prompts a user through steps for replacing a low voltage battery. The low voltage battery may be coupled to other power sources when the low voltage bus is electrically coupled to a low voltage bus.

### FIELD

The present description relates to methods and a system for replacing a low voltage battery that may selectively receive power from a high voltage bus.

### BACKGROUND

A vehicle may include a low voltage battery to power vehicle systems including but not limited to infotainment systems, lighting, windshield wipers, etc. For vehicles that are propelled via an internal combustion engine, the low voltage battery may be the sole voltage source carried on the vehicle. Therefore, when the low voltage battery is being replaced, little if any electric power may flow through battery leads once the battery leads are disconnected from battery terminals. However, some newer vehicles may include two or more electric power sources that are electrically coupled to the battery leads.

The background above is provided to introduce in simplified form a selection of concepts that are further described in the detailed description. It is not meant to identify key features of the claimed subject matter, the scope of which is defined by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic diagram of an electric vehicle driveline;

FIG. 2 is an example schematic diagram of a low voltage electric power distribution system is shown;

FIG. 3 shows an example operating sequence for installing a low voltage battery; and

FIGS. 4 and 5 show a flowchart of a method for installing a low voltage battery for an electric or hybrid vehicle; and

FIGS. 6-9 show example human/machine interface prompts.

### DETAILED DESCRIPTION

The present description is related to a method and system for installing a low voltage battery of an electric or hybrid vehicle. The method describes a procedure that guides a user of the vehicle through installation of a low voltage battery. The user may interface with a human/machine interface. The interaction between the human/machine interface and the user may increase the user’s confidence level that the low voltage battery is being replaced in a preferred way. Additionally, the vehicle may perform functions in concert with user input to lower a possibility of discharging a low voltage power distribution bus during replacement of a low voltage battery.

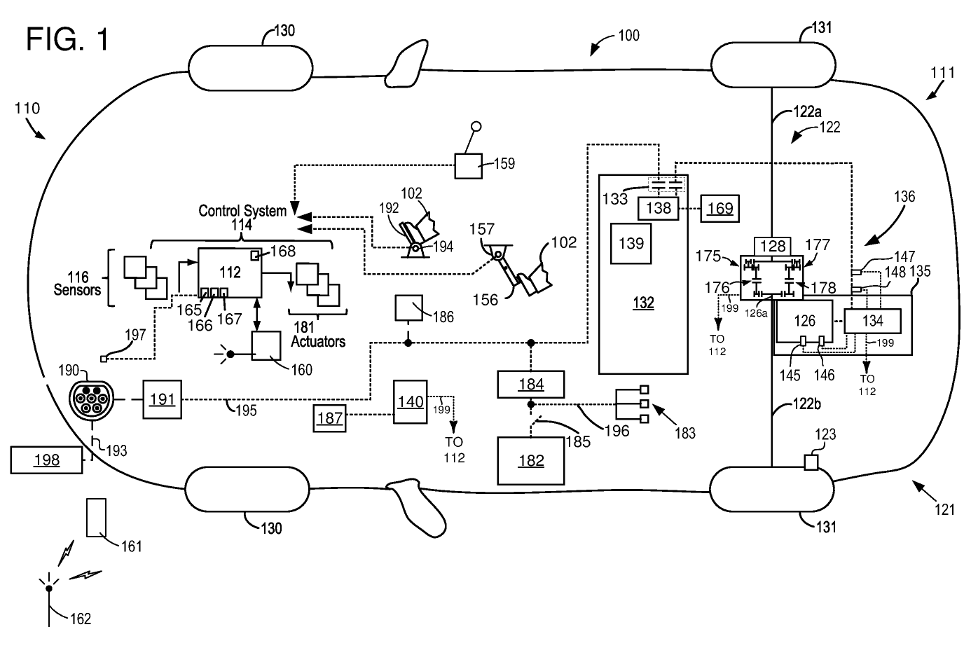

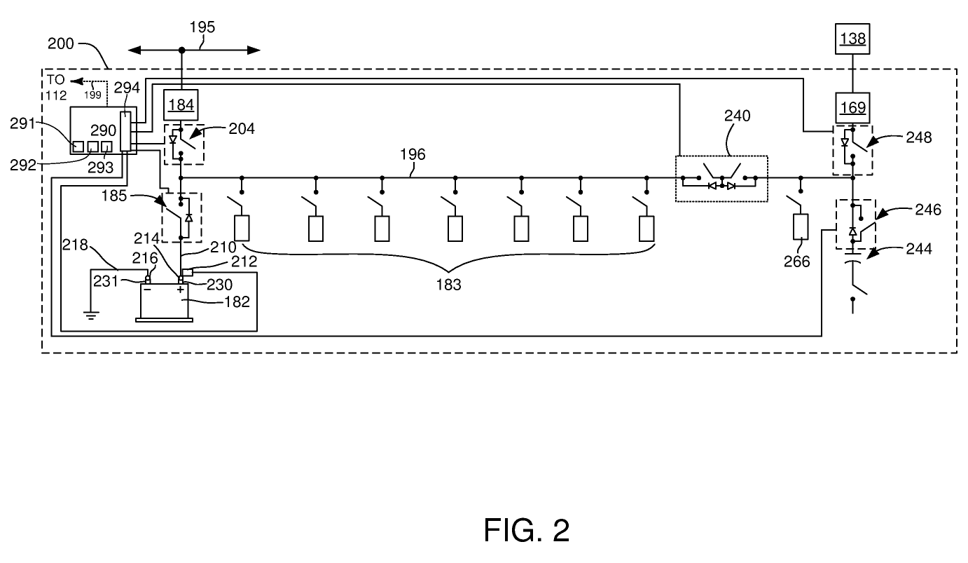

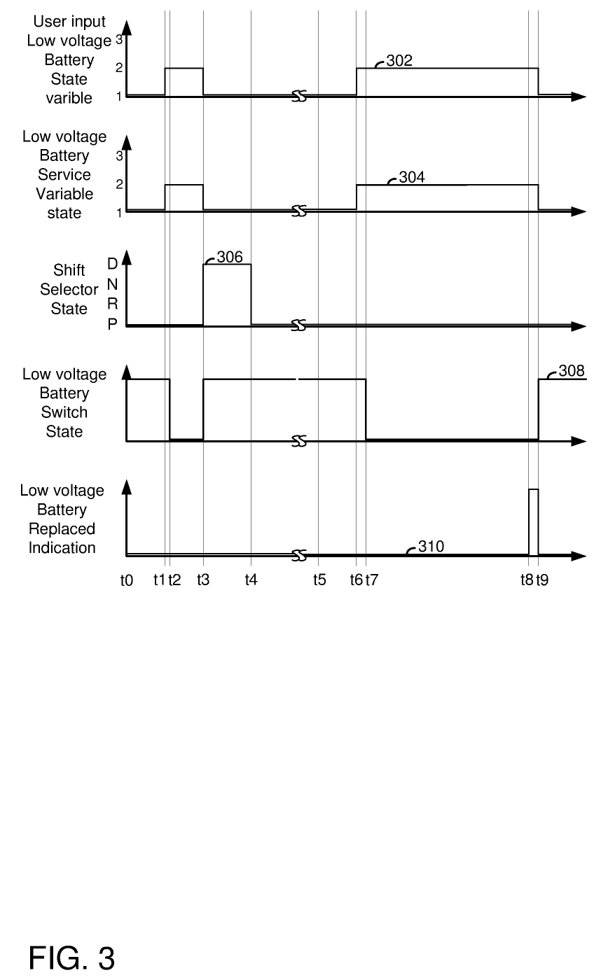

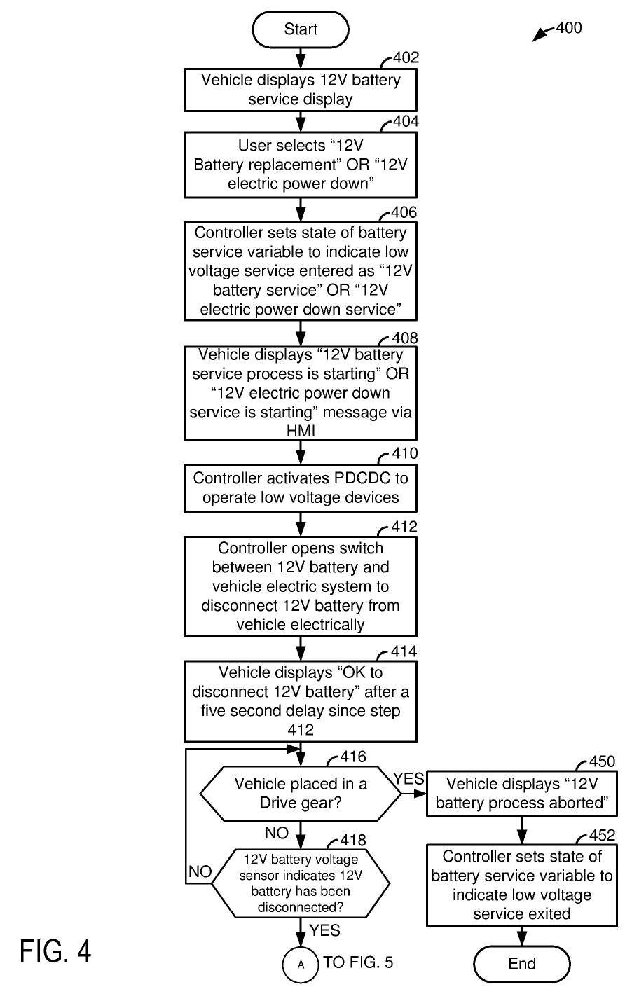

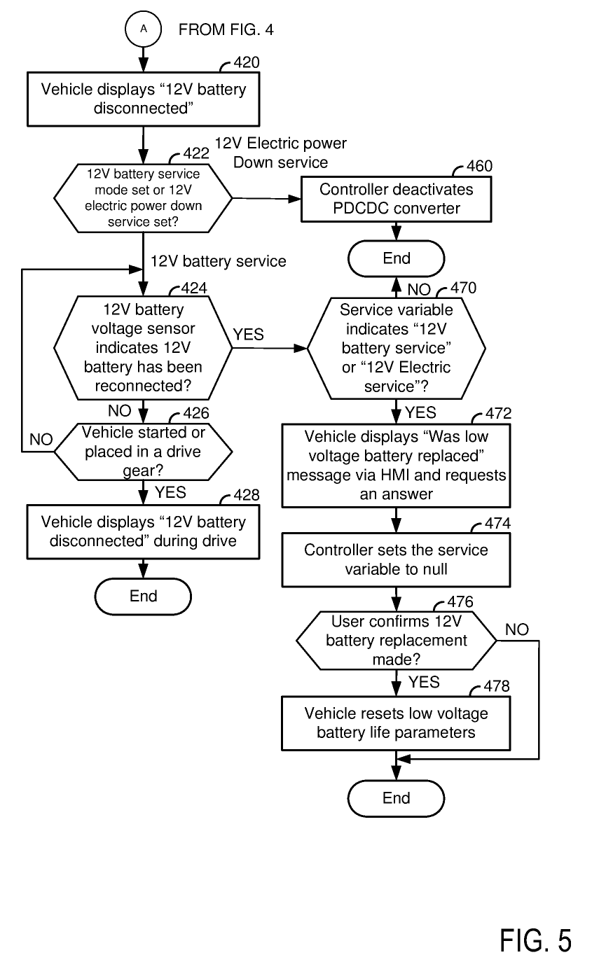

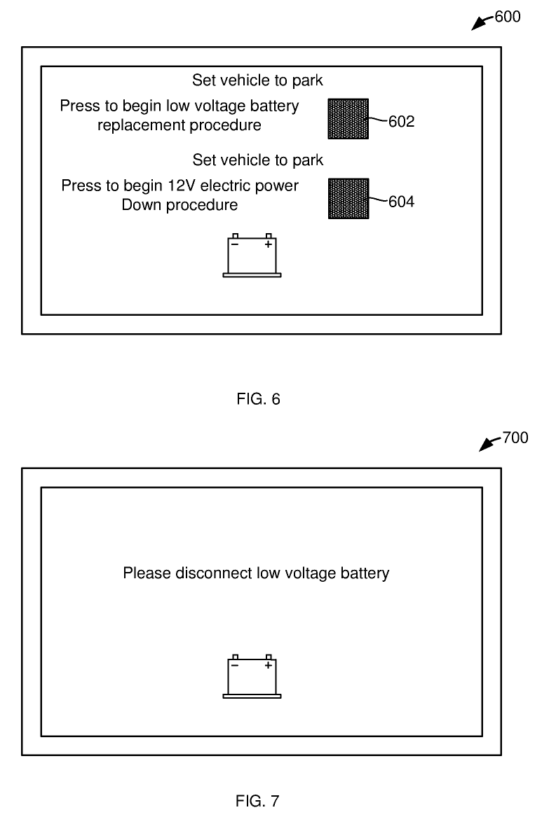

An example electric vehicle is shown in FIG. 1. An example low voltage power distribution system for the electric vehicle of FIG. 1 is shown in FIG. 2. An example operating sequence for the vehicle according to the method of FIGS. 4-5 is shown in FIG. 3. A method for replacing a low voltage battery is shown in FIGS. 4-5. Finally, FIGS. 6-9 show example prompts that may be generated via a human/machine interface.

Electric vehicles and hybrid vehicles may include a traction battery and a low voltage battery. The traction battery is a higher voltage battery (e.g., > 60 volts) that supplies electric power to an electric machine that may propel the vehicle. The low voltage battery (e.g., 12 volts) is a battery that may supply electric power to ancillary devices that do not provide propulsive effort to the vehicle. The low voltage battery may be electrically coupled to a low voltage bus and the low voltage bus may be electrically coupled a DC to DC power converter that allows electric power to be transferred from the high voltage bus to the low voltage bus. This arrangement allows the traction battery to power the low voltage bus while the vehicle is moving, charging, and also when the vehicle is stationary with the propulsion system powered down. However, this arrangement may also allow a disadvantage of a voltage being present at battery leads after the battery leads are disconnected from the low voltage battery. Consequently, special handling of the low voltage battery leads after the low voltage battery is disconnected may be considered.

The inventors herein have recognized the above-mentioned disadvantages and have developed a method for operating a vehicle, comprising: via a controller, prompting input to enter a low voltage battery replacement procedure; and opening a switch arranged between a low voltage battery and a low voltage bus in response to receiving input to enter the low voltage battery replacement procedure.

By prompting a user to provide input to a human/machine interface, the user may be guided through an installation procedure for a low voltage battery. The procedure may reduce a possibility of charge flowing from a low voltage bus to battery leads, especially if the positive battery lead were to contact the vehicle chassis system, which is commonly the electrical ground. Additionally, the procedure may increase the user’s confidence that the procedure is being performed in a desired way.

The present description may provide several advantages. In particular, the approach may ease installation for a user installing a low voltage battery of an electric or hybrid vehicle. Further, the approach may take mitigating actions if the user interrupts the procedure with an unexpected action. In addition, the approach reduces a possibility of discharging a DC bus via battery leads that have been removed from battery terminals.

The above advantages and other advantages, and features of the present description will be readily apparent from the following Detailed Description when taken alone or in connection with the accompanying drawings.

FIG. 1 is a block diagram of an example vehicle propulsion system 100 for vehicle 121. A front portion of vehicle 121 is indicated at 110 and a rear portion of vehicle 121 is indicated at 111. Vehicle propulsion system 100 includes electric machine 126. Electric machine 126 may consume or generate electrical power depending on its operating mode. Throughout FIG. 1, mechanical connections between various components are illustrated as solid lines, whereas electrical connections between various components are illustrated as dashed lines.

Vehicle propulsion system 100 has a rear axle 122. In some examples, rear axle 122 may comprise two half shafts, for example first half shaft 122a, and second half shaft 122b. Vehicle propulsion system 100 further has front wheels 130 and rear wheels 131. Rear wheels 131 may be driven via electric machine 126.

The rear axle 122 is coupled to electric machine 126. Rear drive unit 136 may transfer power from electric machine 126 to axle 122 resulting in rotation of rear wheels 131. Rear drive unit 136 may include a low gear 175 and a high gear 177 that are coupled to electric machine 126 via output shaft 126a of electric machine 126. Low gear 175 may be engaged via fully closing low gear clutch 176. High gear 177 may be engaged via fully closing high gear clutch 178. High gear clutch 178 and low gear clutch 176 may be opened and closed via commands received by rear drive unit 136 over controller area network (CAN) 199. Alternatively, high gear clutch 178 and low gear clutch 176 may be opened and closed via digital outputs or pulse widths provided via control system 114. Rear drive unit 136 may include differential 128 so that torque may be provided to first half shaft 122a and to second half shaft 122b. In some examples, an electrically controlled differential clutch (not shown) may be included in rear drive unit 136.

Electric machine 126 may receive electrical power from onboard electrical energy storage device (e.g. a traction battery) 132. Furthermore, electric machine 126 may provide a generator function to convert the vehicle’s kinetic energy into electrical energy, where the electrical energy may be stored at electric energy storage device 132 for later use by electric machine 126. An inverter system controller 134 (ISC1) may convert alternating current generated by electric machine 126 to direct current for storage at the electric energy storage device 132 and vice versa. Electric drive system 135 includes electric machine 126 and inverter system controller 134. Electric energy storage device 132 may be a battery, capacitor, inductor, or other electric energy storage device. Electric power flowing into electric drive system 135 may be monitored via current sensor 145 and voltage sensor 146. Position and speed of electric machine 126 may be monitored via position sensor 147. Torque generated by electric machine 126 may be monitored via torque sensor 148.

Electric machine 126 may propel vehicle 121 in a forward direction or reverse direction in response a position of shift selector 159. Further, vehicle 121 may enter park (e.g., no vehicle movement with vehicle wheels locked) or neutral in response to a position of shift selector 159.

In some examples, electric energy storage device 132 may be configured to store electrical energy that may be supplied via a high voltage bus 195 (e.g., components such as conductors that carry electric current and high voltage (e.g., voltage greater than 60 volts). High voltage bus 195 may be in electrical communication with high voltage vehicle accessories (e.g., heat pump, air conditioner, heater, etc.) 186 and power converter 191 (e.g., direct current (DC) to DC converter or alternating current (AC) to DC converter). Power converter 191 is electrically coupled to electrical receptacle 190 and electrical receptacle 190 may be electrically coupled to an external stationary electric power grid 198 (e.g., a charging station) via cord 193. Receptacle sensor 197 provides an indication of whether or not vehicle 121 is plugged in to the stationary electric power grid 198. Stationary electric power grid 198 resides external to the vehicle (e.g., not part of the vehicle). High voltage bus 195 may also be electrically coupled to a DC/DC converter 184, which allows electric power to be transferred from high voltage bus 195 to low voltage bus 196 (e.g., conductors, terminals, and other conductive linking devices). Thus, electric power may be exchanged between electric energy storage device 132 and low voltage battery 182 (e.g., battery voltage of less than 20 volts). Low voltage battery switch 185 may be selectively opened to prevent power to low voltage battery 182 (e.g., 12 volts DC) from low voltage bus 196. Low voltage bus 196 may distribute low voltage electric power to low voltage electric loads 183 (e.g., electric power consumers such as infotainment system, windshield wipers, blowers, etc.).

Returning to FIG. 1, electric energy storage device 132 includes an electric energy storage device controller 139 and a power distribution module 138. Electric energy storage device controller 139 may provide charge balancing between energy storage element (e.g., battery cells) and communication with other vehicle controllers (e.g., controller 112). Power distribution module 138 controls flow of power into and out of electric energy storage device 132. A contactor 133 may selectively couple and decouple electric energy storage device 132 to high voltage bus 195 and inverter system controller (ISC1) 134. In some examples, contactor 133 may be located external to the electric energy storage device 132. Power distribution module 138 is also shown directly electrically coupled to protected DC/DC converter 169.

Control system 114 may communicate with electric machine 126, energy storage device 132, navigation system 187, etc. Control system 114 may receive sensory feedback information from electric drive system 135 and electric energy storage device 132, etc. Further, control system 114 may send control signals to electric drive system 135 and electric energy storage device 132, etc., responsive to this sensory feedback. Control system 114 may receive an indication of an operator requested output of the vehicle propulsion system from a human operator 102, or an autonomous controller. For example, control system 114 may receive sensory feedback from pedal position sensor 194 which communicates with pedal 192. Pedal 192 may refer schematically to a driver demand pedal. Similarly, control system 114 may receive an indication of an operator (e.g., user) requested vehicle slowing via a human operator 102, or an autonomous controller. For example, control system 114 may receive sensory feedback from pedal position sensor 157 which communicates with vehicle slowing pedal 156.

One or more wheel speed sensors (WSS) 123 may be coupled to one or more wheels of vehicle propulsion system 100. The wheel speed sensors may detect rotational speed of each wheel. Such an example of a WSS may include a permanent magnet type of sensor.

Controller 112 may comprise a portion of a control system 114. In some examples, controller 112 may be a single controller of the vehicle. Control system 114 is shown receiving information from a plurality of sensors 116 (various examples of which are described herein) and sending control signals to a plurality of actuators 181 (various examples of which are described herein). As one example, sensors 116 may include tire pressure sensor(s) (not shown), wheel speed sensor(s) 123, etc. In some examples, sensors associated with electric machine 126, wheel speed sensor 123, etc., may communicate information to controller 112, regarding various states of electric machine operation. Controller 112 includes non-transitory (e.g., read exclusive memory) 165, random access memory 166, digital inputs/outputs 168, and a microcontroller 167. Controller 112 may receive input data and provide data to human/machine interface 140 via CAN 199. Additionally, controller 112 may send vehicle data and receive command instructions (e.g. a request to prepare the vehicle for extended storage) via transceiver 160 and remote device 161 (e.g., cell phone, tablet, or other remote wireless device). Remote device 161 may transmit commands and receive data via cellular or satellite network 162.

Referring now to FIG. 2, a schematic diagram of a low voltage electric power distribution system is shown. Conductors are shown in FIG. 2 as solid lines linking the various components that are shown.

Low voltage electric power distribution system 200 includes low voltage battery 182 and low voltage battery 182 includes positive battery terminal 230 and negative battery terminal 231. Negative clamp 216 may couple negative battery lead 218 to negative battery terminal 231. Positive clamp 214 may couple positive battery lead 210 to positive battery terminal 230. Switch 185, as shown with the diode, still permits power flow from to the low voltage bus from the 12V battery through the diode. However, with switch 185 open, electric power cannot flow from the low voltage bus to the 12V battery. In this example, low voltage battery switch 185 is shown in a field effect transistor arrangement that includes a diode. However, in other examples, battery switch may be a contactor, bi-polar transistor, or other know switching device.

Low voltage electric power distribution system 200 also includes bidirectional DC/DC converter 184 that may electrical couple high voltage bus 195 to low voltage bus 196 via DC/DC converter switch 204. In this example, DC/DC converter switch 204 is shown in a field effect transistor arrangement that includes a diode. However, in other examples, DC/DC converter switch may be a contactor, bi-polar transistor, or other know switching device.

Low voltage bus 196 is shown as being split into two sections. A first section includes low voltage electric loads 183 and a second section that includes protected low voltage electric loads 266 (e.g., lights, steering systems, etc.). Power interrupt device 240 may selectively open and decouple low voltage electric loads 183 from protected low voltage electric loads 183 during particular operating conditions (e.g., a reduction in output of low voltage battery 182).

Protected DC/DC converter 169 (PDCDC) may supply electric power to low voltage bus 196 via protected DC/DC converter switch 248. Capacitor 244 may also supply electric power to low voltage bus 196 via capacitor switch 246. The protected DC/DC converter 169 receives electric power from power distribution module 138 and the vehicle’s traction battery to deliver low voltage power the low voltage bus 196.

Low voltage controller 290 includes non-transitory (e.g., read exclusive memory) 291, random access memory 292, digital inputs/outputs 294, and a microcontroller 293. Low voltage controller 290 may communicate with and operate low voltage battery minder 212, low voltage battery switch 185, DC/DC converter switch 204, protected DC/DC converter switch 248, power interrupt device 240, and capacitor switch 246. Low voltage controller 290 may receive input data and provide data to human/machine interface 140 and controller 112 via CAN 199.

Low voltage battery minder 212 may provide a variety of functions including but not limited to low voltage battery state of charge (SOC), voltage level of low voltage battery 182, state of health of low voltage battery 182, and current input and current output of low voltage battery 182. Low voltage battery minder 212 may include a microcontroller, memory, and associated circuitry to provide the recited functions.

Low voltage controller 290 is shown as part of a system with other controllers (e.g., controller 112). However, it may be appreciated that low voltage controller 290 may be integrated with controller 112 or another controller to provide the functionality described herein.

The system of FIGS. 1 and 2 provides for a system, comprising: a vehicle including a battery, a human/machine interface, and a switch; one or more controllers including executable instructions stored in non-transitory memory that cause the one or more controllers to prompt input to initiate a replacement procedure for the battery, open the switch, and provide electric power to the low voltage bus in response to input to initiate the replacement procedure. In a first example, the system further comprises a low voltage bus and battery leads, the battery leads electrically coupled to the low voltage bus, and where the switch is positioned between the battery and the low voltage bus. In a second example that may include the first example, the system further comprises a DC/DC converter and a high voltage bus, the DC/DC converter arranged between the high voltage bus and the low voltage bus, and where the DC/DC converter supplies electric power to the low voltage bus. In a third example that may include one or both of the first and second examples, the system further comprises a shift selector and additional executable instructions that cause the switch to close in response to a position of the shift selector. In a fourth example that may include one or more of the first through third examples, the system further comprises additional executable instructions that cause the one or more controllers to prompt removal of battery leads following opening of the switch. In a fifth example that may include one or more of the first through fourth examples, the system further comprises additional executable instructions that cause the one or more controllers to determine that the battery leads are removed and prompt installation of a new battery. In a sixth example that may include one or more of the first through fifth examples, the system includes where prompting input is via the human/machine interface.

Referring now to FIG. 3, an example operating sequence for installing a low voltage battery is shown. The operating sequence of FIG. 3 may be provided via the system of FIGS.1 and 2 in cooperation with the method of FIGS. 4-6. The plots in FIG. 3 are aligned in time and the vertical lines indicate times of interest during the sequence. The double SS marks along the horizontal axis represents a break in time and the duration of the break may be long or short.

The first plot from the top of FIG. 3 is a plot of a user (e.g., human) input low voltage battery state variable. A user may provide input to the human/machine interface to change a value of the user input low voltage battery state variable. The vertical axis represents user input low voltage battery state variable value and user input low voltage state variables are indicated as follows: 1. No input; 2. Request to replace low voltage battery; and 3. Request to power down low voltage system for storing vehicle. The horizontal axis represents time and time increases from the left side of the figure to the right side of the figure. Trace 302 indicates the user input low voltage battery state variable value.

The second plot from the top of FIG. 3 is a plot of a low voltage battery service variable state. The vertical axis represents low voltage battery service variable state and user low voltage battery service variable state values are indicated as follows: 1. Low voltage bus active; 2. Low voltage battery replacement procedure activated; and 3. Low voltage power down. The horizontal axis represents time and time increases from the left side of the figure to the right side of the figure. Trace 304 indicates the low voltage battery service variable state value.

The third plot from the top of FIG. 3 is a plot of a shift selector state and shift selector states include drive – D, park – P, and reverse – R. user (e.g., human) input low voltage battery state variable. A user may change a position of the shift selector to change the shift selector state. The vertical axis represents shift selector state. The horizontal axis represents time and time increases from the left side of the figure to the right side of the figure. Trace 306 represents the shift selector state value.

The fourth plot from the top of FIG. 3 is a plot of a low voltage battery switch state and the low voltage switch is closed when trace 308 is at a higher level near the vertical axis arrow. The low voltage switch is open when trace 308 is at a lower level near the horizontal axis. Trace 308 represents the low voltage battery switch state.

The fifth plot from the top of FIG. 3 is a plot of a low voltage battery replace indication and the low voltage battery replacement indication is asserted when trace 310 is at a higher level near the vertical axis arrow. The low voltage battery replacement indication is not asserted when trace 310 is at a lower level near the horizontal axis. Trace 310 represents the low voltage battery replacement indication.

At time t0, there is no user input and the low voltage battery service variable state indicates that the low voltage battery is not being replaced. The shift selector is in the park state and the low voltage battery switch is closed so that electric power may flow to the low voltage battery. The low voltage battery replaced indication is not asserted.

At time t1, the user provides input to request low voltage battery replacement and the low voltage battery service variable state changes to indicate a low voltage battery replacement procedure has started. The shift selector is in park and the low voltage battery switch remains closed. The low voltage battery replacement indication is not asserted.

At time t2, the user input low voltage battery state variable remains unchanged and the low voltage battery service variable indicates that the low voltage battery replacement sequence is in progress. The shift selector remains in park, but the low voltage battery switch changes state from closed to open so that no current may flow from the DC bus to the low voltage battery. The low voltage battery replacement indication is not asserted because replacement of the low voltage battery has not been confirmed.

At time t3, the shift selector state changes from park to drive. This causes the user input low voltage battery state variable to be reset to a value of one to indicate no user request to replace the low voltage battery. The low voltage battery service variable changes state back to low voltage bus activated, thereby indicating that the low voltage battery may supply power to and receive power from the low voltage bus. The low voltage battery switch changes state from open to closed because engaging the shift selector into drive indicates that the user intends to abort the low voltage battery replacement procedure. The low voltage battery replacement indication is not asserted.

At time t4, the shift selector state changes from drive back to park. The user input low voltage battery state variable is unchanged and the low voltage battery service variable is unchanged. The low voltage battery switch state remains unchanged and the low voltage battery replacement indication is unchanged. Between time t4 and time t5, there is a break in the operating sequence.

At time t5, there is no user input and the low voltage battery service variable state indicates that the low voltage battery is not being replaced. The shift selector is in the park state and the low voltage battery switch is closed so that electric power may flow to the low voltage battery. The low voltage battery replaced indication is not asserted.

At time t6, the user provides input to request low voltage battery replacement and the low voltage battery service variable state changes to indicate a low voltage battery replacement procedure has started. The shift selector is in park and the low voltage battery switch remains closed. The low voltage battery replacement indication is not asserted.

At time t7, the user input low voltage battery state variable remains unchanged and the low voltage battery service variable indicates that the low voltage battery replacement sequence is in progress. The shift selector remains in park, but the low voltage battery switch changes state from closed to open so that no current may flow from the DC bus to the low voltage battery. The low voltage battery replacement indication is not asserted because replacement of the low voltage battery has not been confirmed.

At time t8, the user indicates that the low voltage battery has been replaced with a new low voltage battery and the low voltage battery replaced indication is asserted. The user input low voltage battery state variable remains unchanged and the low voltage battery service variable remains unchanged. The shift selector remains in park and the low voltage battery switch remains open.

At time t9, the low voltage battery switch state changes from open to closed in response to the low voltage battery replaced indication, thereby causing the low voltage battery replacement indication to be reset to no longer indicate that the low voltage battery has been replaced. Additionally, the user input low voltage battery state variable is reset to a value of one and the low voltage battery service variable state is reset back to a value of one to indicate that the low voltage battery is no longer engaged in the battery replacement procedure.

In this way, a user may be coached through a replacement procedure for a low voltage battery and a portion of the low voltage battery replacement procedure includes taking actions to reduce a possibility of current flow through battery leads during a low voltage battery replacement procedure. Further, if the user changes a position of a shift selector, the change may be interpreted as an acknowledgement that the user wishes to abandon the low voltage battery replacement procedure.

Turning now to FIGS. 4 and 5, a flowchart of a method 400 for installing a low voltage battery for an electric or hybrid vehicle is shown. The method of FIGS. 4 and 5 may be performed in part via a human and in part via one or more controllers in the system of FIGS. 1 and 2. At least a portion of the method of FIGS. 4 and 5 may be stored as executable instructions stored in non-transitory memory of a controller.

At 402, the vehicle displays a 12V (12 volt) battery service display via the vehicle’s human/machine interface (HMI) and prompts the user for input. FIG. 6 shows an example of a HMI display message that prompts the user for input. Method 400 proceeds to 404.

At 404, the user (e.g., human) provides input to a human/machine interface to request initiation of a low voltage battery replacement procedure or low voltage electric power down (e.g., shut off power to the vehicle’s low voltage bus or power distribution system). Method 400 proceeds to 406 upon receiving the requested user input.

At 406, the one or more controllers set a state of battery service variable to a value that indicates that low voltage service mode is being entered a “12V battery service” or “12V electric power down service.” The state of battery service variable lets other systems and control routines determine the operating state of the low voltage power distribution system. Method 400 proceeds to 408.

At 408, the one or more controllers has the vehicle’s HMI display “12V battery service process starting” or “12V electric power down service is starting.” Method 400 proceeds to 410.

At 410, the one or more controllers activate the protected DC/DC (PDCDC) converter to supply power the low voltage bus and low voltage consumers. The PDCDC receives electric power via the high voltage bus and converts the electric power to low voltage electric power, which is supplied to the low voltage bus. Activating the PDCDC allows the 12V battery to be disconnected from the low voltage bus with a reduced possibility of arcing between the low voltage battery and battery leads. Activating the PDCDC also reduces a possibility of the voltage of the low voltage bus from dropping below a threshold voltage and 12V power consumers (e.g., the HMI) to remain operational so that messaging to the user may be maintained. Additionally, activating the PDCDC allows the vehicle to abort battery replacement or power disconnect if the vehicle is activated and engaged in a driving gear. Method 400 proceeds to 412.

At 412, the one or more controllers open a switch (e.g., 185 of FIG. 2) between the 12V battery and the vehicle’s electric system (e.g., Low voltage bus) to disconnect the 12V battery from the vehicle electrically. Method 400 proceeds to 414.

At 414, the one or more controllers has the HMI display “OK to disconnect 12V battery” after a five second delay following step 412. Method 400 proceeds to 416.

At 416, method 400 judges whether or not the vehicle is engaged in a drive gear (e.g., a gear that may transfer torque to propel the vehicle in forward or reverse). The one or more controllers may sense a position of a dog clutch or shift actuator to determine if a drive gear is presently engaged. If method 400 judges that the vehicle is engaged in a drive gear, the answer is yes and method 400 proceeds to 450. Otherwise, the answer is no and method 400 proceeds to 418.

At 450, the vehicle displays a message “12V battery process aborted” via the controller and the HMI. Optionally, method 400 may close the low voltage battery switch. Method 400 proceeds to 452.

At 452, the one or more controllers set the state of battery service variable to indicates that low voltage service mode is exited. Method 400 proceeds to exit.

At 418, method 400 judges if the 12V battery voltage sensor indicates 12V battery has been disconnected from the vehicle’s low voltage bus. The 12V battery voltage sensor may indicate that the 12V battery is disconnected via a change in voltage when the voltage on sensor 212 indicates the positive battery terminal has been disconnected. If the 12V battery sensor 212 indicates that the 12V battery is disconnected from the vehicle’s low voltage bus, the answer is yes and method 400 proceeds to 420. Otherwise, the answer is no and method 400 returns to 416.

At 420, the one or more controllers has the vehicle’s HMI display “12V battery disconnected.” Method 400 proceeds to 422.

At 422, the one or more controllers judge if the 12V battery service mode is set or if 12V electric power down service is set. Method 400 may determine which mode has been set based on the value that is stored in the battery service variable that was set at step 406. If method 400 judges that 12V battery service mode is set, method 400 proceeds to 424. If method 400 judges that 12V electric power down service mode is set, method 400 proceeds to 460.

At 460, the one or more controllers deactivates the protected DC/DC converter. Method 400 proceeds to exit.

At 424, method 400 judges if the 12V battery voltage sensor indicates 12V battery has been reconnected to the vehicle’s low voltage bus. The 12V battery voltage sensor may indicate that the 12V battery is disconnected via a change in voltage when the disconnect switch is closed. If the 12V battery sensor indicates that the 12V battery is reconnected to the vehicle’s low voltage bus, the answer is yes and method 400 proceeds to 470. Otherwise, the answer is no and method 400 proceeds to 426.

At 426, method 400 judges if the vehicle is started (e.g., one or more of the vehicle’s traction motor inverters are activated) or if the vehicle is engaged in a drive gear. If so, the answer is yes and method 400 proceeds to 428. Otherwise, the answer is no and method 400 returns to 424.

At 428, the vehicle displays “12V battery disconnected” message via the one or more controllers and the HMI. The message may be displayed when the vehicle is engaged in a drive gear. Method 400 proceeds to exit.

At 470, the one or more controllers judge if the 12V battery service mode is set or if 12V electric power down service is set. Method 400 may determine which mode has been set based on the value that is stored in the battery service variable that was set at step 406. If method 400 judges that 12V battery service mode or the 12V electric power down service is set, the answer is yes and method 400 proceeds to 472. If method 400 judges that 12V battery service mode or the 12V electric power down service is not set, the answer is no and method 400 proceeds to exit.

At 472, method 400 displays “Was low voltage battery replaced” message via the HMI and requests input regarding the displayed message. Method 400 proceeds to 474.

At 474, the one or more controllers sets the service variable value to null. Method 400 proceeds to 476.

At 476, method 400 judges if the user has confirmed 12V battery replacement has been made. If so, the answer is yes and method 400 proceeds to 478. Otherwise, the answer is no and method 400 proceeds to exit.

At 478, method 400 resets the low voltage battery life parameters (e.g., Battery life cycles, battery state of health, etc.). Method 400 proceeds to exit.

Thus, method 400 may interactively operate with a user (human) to replace a low voltage battery and/or power down a vehicle for storage. Method 400 may take actions to reduce a possibility of electric current flow during a low voltage battery replacement sequence. Additionally, method 400 may reset to base values low voltage battery monitoring and control parameters.

The method of FIGS. 4 and 5 provides for a method for operating a vehicle, comprising: via a controller, prompting input to enter a low voltage battery replacement procedure via a human machine interface; and opening a switch arranged between a low voltage battery and a low voltage bus in response to receiving input to enter the low voltage battery replacement procedure. In a first example, the method further comprises supplying power to the low voltage bus before and after opening the switch via the power source (e.g., a DC/DC converter). In a second example that may include the first example, the method includes where opening the switch prevents electric current flow from the low voltage bus to battery leads, and where the switch is a transistor. In a third example that may include one or both of the first and second examples, the method further comprises closing the switch in response to a position of a shift selector. In a fourth example that may include one or more of the first through third examples, the method further comprises prompting to physically disconnect battery leads from battery terminals. In a fifth example that may include one or more of the first through fourth examples, the method further comprises monitoring battery leads and determining whether or not the battery leads are disconnected from the battery terminals. In a fifth example that may include one or more of the first through fourth examples, the method further comprises providing an indication that a battery is disconnected based on a voltage at the battery leads. In a sixth example that may include one or more of the first through fifth examples, the method includes prompting for input to acknowledge that the low voltage battery has been replaced.

The method of FIGS. 4 and 5 also provides for a method for operating a vehicle, comprising: via a controller, prompting input to enter a low voltage battery replacement procedure; supplying power to a low voltage bus and opening a switch arranged between a low voltage battery and a low voltage bus in response to receiving input to enter the low voltage battery replacement procedure; and closing the switch in response to a position of a shift selector. In a first example, the method includes where the closing occurs when the shift selector is not in park or neutral. In a second example that may include the first example, the method further comprises prompting input to disconnect the low voltage battery in response to opening the switch. In a third example that may include one or both of the first and second examples, the method further comprises indicating that the low voltage battery is disconnected from the low voltage bus. In a fourth example that may include one or more of the first through third examples, the method further comprises prompting input to determine that the low voltage battery has been replaced.

Referring now to FIG. 6, an example prompt display 600 for beginning a low voltage battery replacement procedure is shown. The prompt display 600 includes a statement as how to begin the low voltage battery replacement procedure and an input 602 to initiate the low voltage battery replacement procedure.

Referring now to FIG. 7, an example display message 700 for informing a user that the low voltage battery may be disconnected from the vehicle is shown. The prompt display 700 may be replaced by other information or an additional prompt when removal of the low voltage battery is detected.

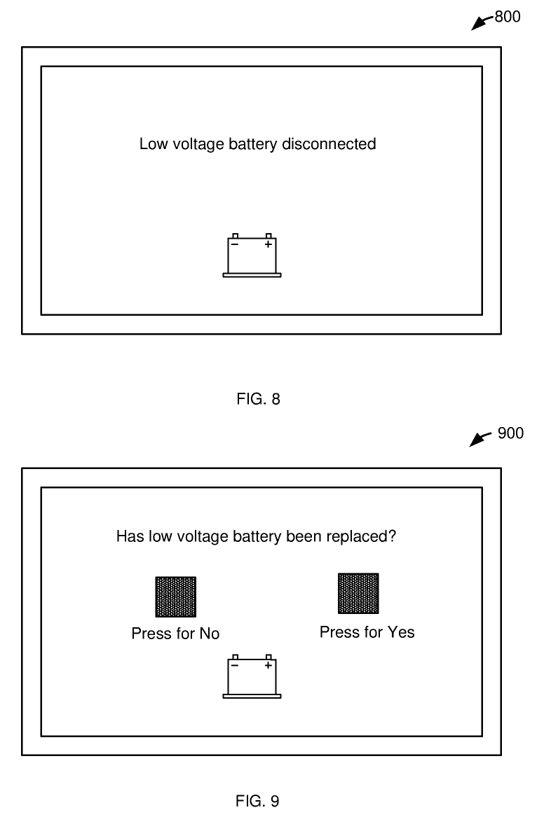

Referring now to FIG. 8, an example display message 800 for indicating that the low voltage battery has been disconnected from the vehicle is shown. The display message 800 may be generated when a voltage at the battery lead is less than 6 volts.

Finally, FIG. 9 shows an example prompt to determine if a new low voltage battery has been electrically coupled to the low voltage bus is shown. Prompt display 900 may be generated when voltage at the battery lead exceeds 6 volts after the low voltage battery has been disconnected from the low voltage bus.

Note that the example control and estimation routines included herein can be used with various vehicle system configurations. The control methods and routines disclosed herein may be stored as executable instructions in non-transitory memory and may be carried out by the control system including one or more controllers in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, at least a portion of the described actions, operations and/or functions may graphically represent code to be programmed into non-transitory memory of the computer readable storage medium in the control system. The control actions may also transform the operating state of one or more sensors or actuators in the physical world when the described actions are carried out by executing the instructions in a system including the various engine hardware components in combination with one or more controllers.

This concludes the description. The reading of it by those skilled in the art would bring to mind many alterations and modifications without departing from the spirit and the scope of the description. For example, an anticipated low voltage battery replacement procedure may combine steps shown herein, have fewer steps than are shown herein, or have additional steps than are shown herein without departing from the scope or intent of the present description. Further, the approach may be applied to front drive vehicles, rear drive vehicles, four-wheel drive vehicles, and hybrid vehicles without departing from the scope or intent of the present disclosure. Further, it is anticipated that controller arrangements and electrical component arrangements may deviate from those shown herein without departing from the scope or intent of this disclosure.

1. A method for operating a vehicle, comprising:
via a controller, prompting input to enter a low voltage battery replacement procedure; and
opening a switch arranged between a low voltage battery and a low voltage bus in response to receiving input to enter the low voltage battery replacement procedure.

2. The method of claim 1, further comprising supplying power to the low voltage bus before and after opening the switch via a power source.

3. The method of claim 1, where opening the switch prevents electric current flow from the low voltage bus to battery leads, and where the switch is a transistor.

4. The method of claim 1, further comprising closing the switch in response to a position of a shift selector.

5. The method of claim 4, further comprising prompting to physically disconnect battery leads from battery terminals.

6. The method of claim 5, further comprising monitoring battery leads and determining whether or not the battery leads are disconnected from the battery terminals.

7. The method of claim 6, further comprising providing an indication that a battery is disconnected based on a voltage at the battery leads.

8. The method of claim 7, prompting for input to acknowledge that the low voltage battery has been replaced.

9. A system, comprising:
a vehicle including a battery, a human/machine interface, a switch, and a low voltage bus; and
one or more controllers including executable instructions stored in non-transitory memory that cause the one or more controllers to prompt input to initiate a replacement procedure for the battery, open the switch, and provide electric power to the low voltage bus, in response to input to initiate the replacement procedure.

10. The system of claim 9, further comprising battery leads, the battery leads electrically coupled to the low voltage bus, and where the switch is positioned between the battery and the low voltage bus.

11. The system of claim 10, further comprising a DC/DC converter and a high voltage bus, the DC/DC converter arranged between the high voltage bus and the low voltage bus, and where the DC/DC converter supplies electric power to the low voltage bus.

12. The system of claim 9, further comprising a shift selector and additional executable instructions that cause the switch to close in response to a position of the shift selector.

13. The system of claim 9, further comprising additional executable instructions that cause the one or more controllers to prompt a user for removal of battery leads following opening of the switch.

14. The system of claim 10, further comprising additional executable instructions that cause the one or more controllers to determine that the battery leads are removed and prompt installation of a new battery.

15. The system of claim 9, where prompting input is via the human/machine interface.

16. A method for operating a vehicle, comprising:
via a controller, prompting input to enter a low voltage battery replacement procedure;
supplying power to a low voltage bus and opening a switch arranged between a low voltage battery and the low voltage bus in response to receiving input to enter the low voltage battery replacement procedure; and
closing the switch in response to a position of a shift selector.

17. The method of claim 16, where the closing occurs when the shift selector is not in park or neutral, and where supplying power to the low voltage bus includes supplying power to the low voltage bus via a DC/DC converter while the switch is open.

18. The method of claim 16, further comprising prompting input to disconnect the low voltage battery in response to opening the switch.

19. The method of claim 18, further comprising indicating that the low voltage battery is disconnected from the low voltage bus.

20. The method of claim 16, further comprising prompting input to determine that the low voltage battery has been replaced.
